(19) United States
(12) Patent Application Publication
(10) Pub. No.: US 2004/0078786 A1
(43) Pub. Date: Apr. 22, 2004

(54) System and method for editing computer-generated documents independently of the creater software application

(76) Inventors: Ronald Francis Hoolahan, West Pennant Hills New South Wales (AU); Warwick John Davis, Woy Woy New South Wales (AU); Alejandro Guillermo Campos, Baulkham Hills New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/466,696

(22) PCT Filed: Jan. 21, 2002
(86) PCT No.: PCT/AU02/00059

(30) Foreign Application Priority Data
Jan. 19, 2001 (AU) PR 2643

(51) Int. Cl. G06F 9/45

(52) U.S. Cl. 717/136; 717/123; 715/530

(57) ABSTRACT

A method and system are disclosed for editing a document to be rendered independently of one or more computer software application program/s used to generate the original document. One or more computer files, representative of the document to be rendered, are generated for describing at least a portion of the document. At least one of the representative computer files is generated in a device-independent page description language. Subsequently, one or more data fields of one or more of the representative computer file/s may be edited independently of the creator software application program/s and in accordance with predetermined rules.

### FIELD OF THE INVENTION

The present invention relates generally to the rendering of documents generated created using computer software applications programs and more specifically to editing such documents.

### BACKGROUND

PostScript® is a programming language optimised for rendering text and/or graphics on print media or a display monitor. Introduced by Adobe® Systems in 1985, PostScript is a page description language that provides a means for describing objects and/or images in a device-independent manner. An object is described using PostScript without reference to any specific device features (eg. printer resolution) so that the description can be used by any PostScript or PostScript-compatible output device (eg. a laser printer), without modification of the PostScript file.

A PostScript file contains essentially a sequence of instructions that can be interpreted by a computer, along with pertinent data. The instructions may be manually input with the aid of a text editor and sent to an output device that supports the PostScript format. Such an output device then interprets the sequential instructions contained in the PostScript file and displays or prints the relevant pages.

For the most part, however, PostScript files are intended to be generated by computer programs. For example, a document created by a word processor under an Operating System may be sent to an installed PostScript printer driver for printing. The printer driver converts the pages of the document to PostScript code and sends that code to the printer. The printer interprets the PostScript code and prints out the page/s. In this way, a PostScript output file of a document can be generated and later sent to any PostScript—enabled output device, without the need to reload the word processor software application that was used to create the document.

Users frequently desire to edit computer-generated documents, but do not have access to licensed software applications and fonts used to create the original document. Further, customer approval is often necessary for designs, especially in creative industries such as the printing industry. The use of PostScript enables remote editing of prepared documents by customers and electronic transfer of the documents. Electronic transfer greatly reduces the turnaround times required for physical transfer of hardcopy.

Use and electronic transfer of PostScript output files would, to some extent, improve this situation in that the output files would be device-independent. However, editing of an output file by the customer without use of the creator software application remains an unfulfilled requirement.

Consequently, a need clearly exists for a system and method for editing computer-generated documents independently of the software application used to create those files.

### SUMMARY

In accordance with an aspect of the present invention, there is provided a method for editing a document to be rendered. The method includes the steps of generating one or more computer files representative of the document to be rendered, wherein at s least one of the computer files comprises instructions in a page description language for describing at least a portion of the document to be rendered; and editing one or more data fields of at least one of the representative computer files in accordance with predetermined rules. The editing step is performed independently of one or more computer software application programs used to create the original document.

According to another aspect of the present invention, there is provided a system for editing a document to be rendered. The system includes processing means for generating one or more computer files representative of the document to be rendered, wherein at least one of the computer files comprises instructions in a page description language for describing at least a portion of the document to be rendered; and processing means for editing one or more data fields of at least one of the representative computer files in accordance with predetermined rules. The processing means for editing is independent of one or more computer software application programs used to create the original document.

According to a further aspect of the present invention, there is provided a computer program product having a computer readable medium having a computer program recorded therein for editing a document to be rendered. The computer program product includes computer program code means for generating one or more computer files representative of the document to be rendered, wherein at least one of the computer files comprises instructions in a page description language for describing at least a portion of the document to be rendered; and computer program code means for editing one or more data fields of at least one of the representative computer files in accordance with predetermined rules. The computer program code means for editing is independent of one or more computer software application programs used to create the original document.

Preferably, a further computer file representative of the edited document is generated in a page description language, wherein data field/s in the further computer file are modified in accordance with editing changes made to one or more of the secondary representative computer file/s and in accordance with predetermined rules.

Preferably, the edited document is rendered independently of one or more computer software application programs used to create the original document.

### DESCRIPTION OF THE DRAWINGS

Features and advantages of the embodiments of the invention are hereinafter described with reference to the accompanying drawings, in which:

FIG. 1 is a flow diagram illustrating a method for editing a computer-generated document independently of the software application/s used to create the document in accordance with a preferred embodiment of the invention;

FIG. 2 is a block diagram illustrating a system for document creation and electronic transfer between the document creator and another party in accordance with the embodiments of the invention;

FIG. 3 is a detailed flow diagram of a method for the generation of a revised output file for hardcopy purposes, with incorporation of edit changes performed by the other party in accordance with the preferred embodiment of the invention; and

FIG. 4 is a block diagram of a computer with which the embodiments of the invention may be practiced.

### DETAILED DESCRIPTION

The principles of the preferred method and system described herein have general applicability to any computer files or documents created with the aid of software application programs. However, for ease of explanation, the preferred method and system are described with reference to the preparation of proofs of documents in the printing industry, and editing and acceptance of those proofs by a customer before bulk printing commences. Furthermore, the PostScript file format is used as a preferred device-independent output file format. Nevertheless, it should be apparent to a person skilled in is the art in view of this disclosure that an alternative device-independent output file format may serve the same purpose. A specific advantage of the PostScript format is that this format is, or can be, generated by most desktop publishing applications.

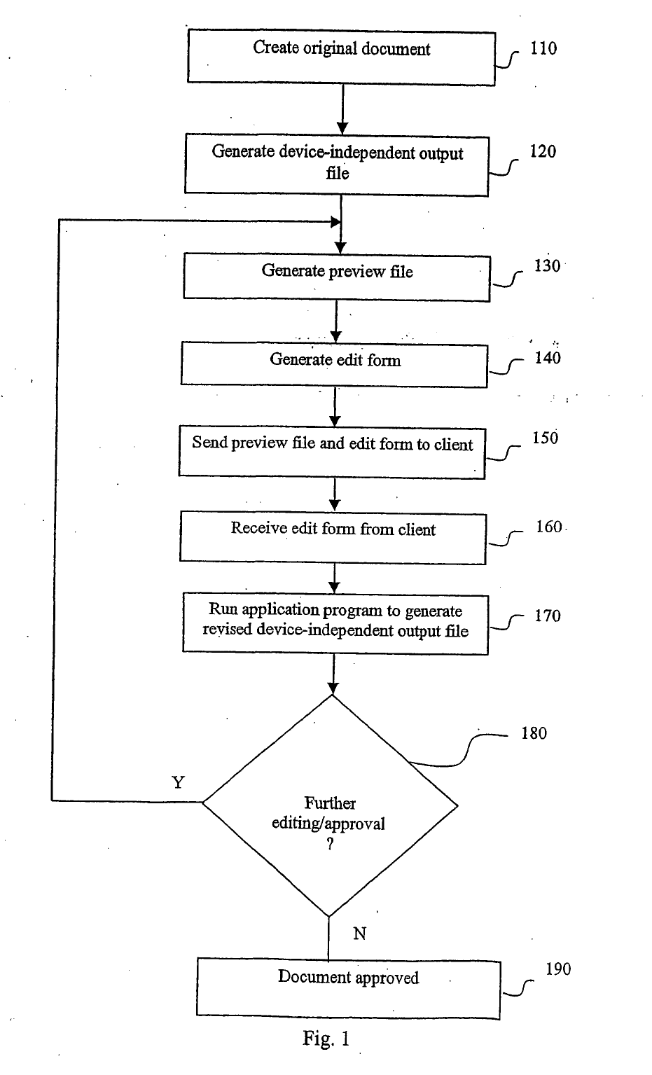

FIG. 1 is a flow diagram illustrating a method for editing a computer-generated document independently of the software application program/s used to create the document. An original document is created by a graphic artist (from a printing bureau, for example) with the aid of a particular software application program, such as a desktop publishing program, at step 110. Such an original document may be created in response to a customer request. Alternatively, various documents templates can be created that define a ‘blank’ document layout. The templates can be stored on a computer server and be made selectively available to customers or potential customers for data entry and other purposes (e.g. via a web-site of the printing bureau). The server can access a relational database containing fields relating to variable text/objects, attributes of those text/objects and possible values that can be inserted into the document templates based on the editing performed by a customer. A customer is thus able to use one or more document templates to create a document, subject to authorisation (e.g. certain templates will only be available to particular companies or organisations and even only to certain personnel in those. companies or organisations). Documents created typically reference multiple computer files such as the document templates and information contained in the relational database. The links between the multiple computer files are typically embedded in the code and/or databases.

At step 120, a device-independent (e.g. PostScript) output file is generated from the original document or templates. In the event that the creator software application program is unable to generate a device-independent output file, an independent software application can be used to generate a device-independent output file. The device-independent output file may also reference other computer files such as font information.

Next, at step 130, a preview file of the document is generated. The preview file is intended for display on a computer display monitor or for hardcopy purposes and is typically of a known format such as GIF or JPEG.

Then, at step 140, an edit form is generated [from the PostScript output file]. The edit form includes variable data fields, each of which correspond to data fields in the PostScript output file.

The edit form is preferably generated in the Hyper Text Mark-up Language (HTML). HTML permits viewing and editing of files or documents by means of prevailing standard web-browser application software such as Internet Explorer™ or Netscape Navigator™. With reference to client-server terminology, a web-browser represents a client.

The preview file and edit form are sent to a customer for editing and/or approval, at step 150. Transfer of the preview file and edit form can be effected by physical media transfer (eg. floppy disk or CD ROM) or electronically (eg. Via the Internet, an intranet, any other network, a direct communications link, or any client-server relationship).

After viewing the preview file, edit changes can be made to the data fields of the edit form by the customer. As the edit form is in HTML format, the form can be edited by means of standard web-browser software and independently of the software application used to create the original document. The edit form is then returned to the printing bureau, at step 160. Return of the edit form may be, but is not necessarily, by the same means as for previous transfer of the edit form from the printing bureau to the customer.

Once the edit form is received by the printing bureau, a proprietary software application program implements a process to identify and validate any changes requested by the customer in the edit form and to generate a revised PostScript output file which incorporates the edited changes, at step 170. The PostScript output file may reference other computer files such as font information.

If further editing or subsequent approval of the edited document is required (Y), at decision step 180, processing returns to step 130. In this case, a further preview file and edit form are generated and transferred to the customer. If further editing or approval is not required (N), at decision step 180, the document is accorded “approved” status, at step 190. For example, the printing bureau may then commence production.

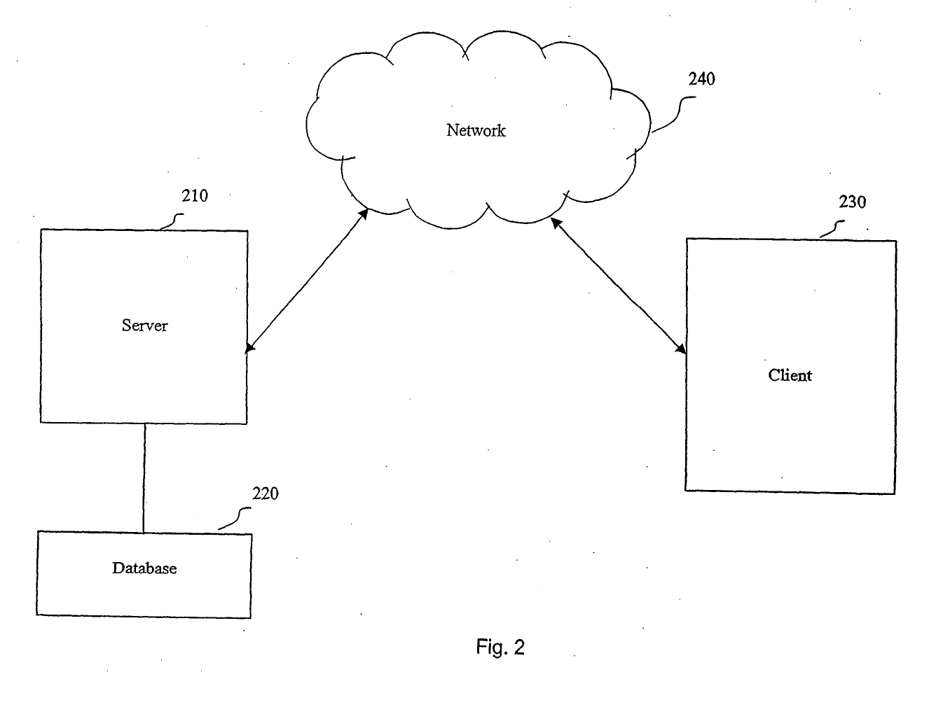

FIG. 2 is a block diagram illustrating a system for document creation and electronic transfer between the document creator and another party. Creation of the lo original document and/or document templates is performed with the aid of a software program that is hosted by the application server 210. The application server 210 may comprise multiple servers and is linked to a database 220. The database 220 includes font, image and template data used by the creator software application/s that execute on the application server 210. The application server 210 is connected to a client computer 230 via a network 240. The client computer 230 may include a computer belonging to a customer of the printing bureau. The network 240 may include the Internet, a Wide Area Network (WAN), a Local Area Network (LAN), a direct communication link, any client-server relationship, or any combination of these.

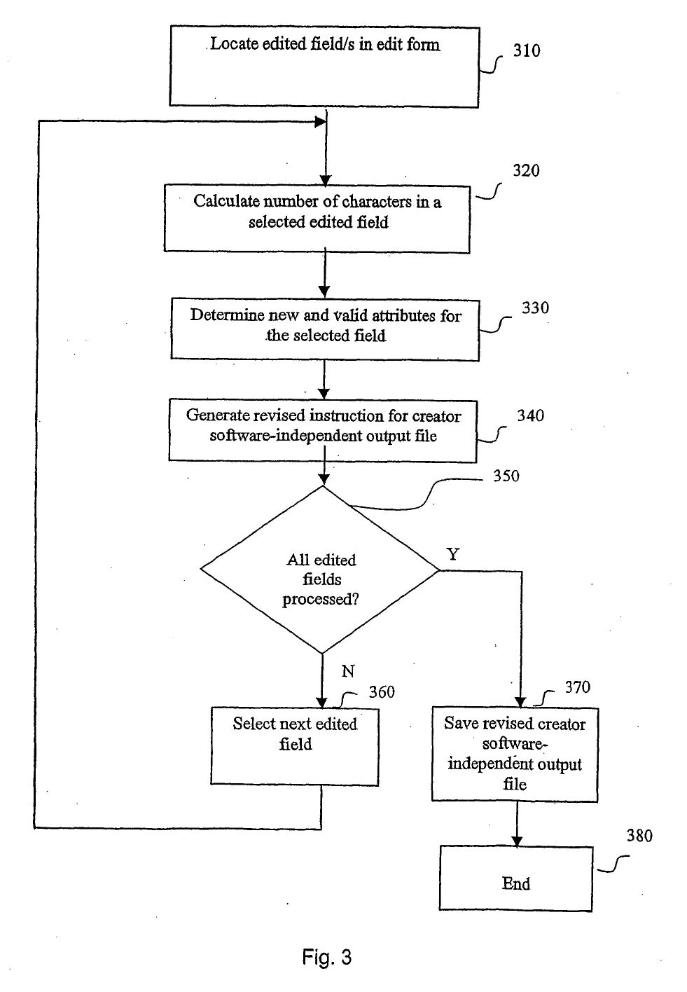

FIG. 3 is a flow diagram of a proprietary software application program in accordance with the preferred embodiment for identifying and formatting edit changes requested in an edit form by a customer and for generating a revised version of the PostScript output file.

Firstly, at step 310, the edit form received from the customer is processed to locate any edit fields edited by the customer. One manner of performing this function is to compare the fields of the edit file to the associated fields in the corresponding Postscript output file. Differences in these fields are indicative of edit changes performed by the customer.

Then, at step 320, the proprietary software application program calculates the number of characters entered into a selected edited field of the edit form.

Next, at step 330, the proprietary software application program determines new and valid values for the attributes or contents of a selected edited field. Such attributes may include the font size, spacing, length and position of a line of text. The position of objects (text or images) is represented by X and Y co-ordinates and object colours are represented by colour values, linked to a colour palette by means of a look-up table.

If an edit by a customer requires a longer line of text than possible due to some physical restriction, such as a maximum width defined by the template, scaling of font size and/or spacing in a controlled fashion can limit the length of the line of text.

New instructions are generated for a revised PostScript output file, based on validated edit changes requested by the customer in the edit form, at step 340.

At decision step 350, a check is made to determine whether all the edit fields have been processed. If all the edit fields have been processed (Y), the revised PostScript output file is saved. The proprietary software application program then terminates at step 380.

If there are still edited fields to be processed by the proprietary software application program (N) at step 350, the next field to be edited is selected, at step 360. Processing then returns to step 320.

### BUSINESS CARD EXAMPLE

A typical example of an application of the described method is for the design of a business card, as described below.

A graphic artist at a printing bureau begins by creating a business card for a customer, using a particular software application program. Once complete, a PostScript output file of the business card is generated, by the creator software application. The is application server as an HTML application generates a thumbnail preview file of the business card for approval by the customer. If changes are required, a form is presented in HTML, with data fields that can be edited.

A proprietary software application program is then used to generate and edit fields from the PostScript output file. Variable data fields in the edit form correspond to fixed data fields in the PostScript output file and may include: company name, address, city, state, postcode, telephone number, email address, mobile number, facsimile number, employee name, employee title, and any other field or image.

Each field has certain values representing variables such as the number of characters, colour, size, font style and text position in that field. The values can be found preceding each of the fields in the PostScript code. The following example is an extract of a PostScript output file with no employee name filled in:

1 setchc 0 0 0 1 C

2 9 9 f

46.3543 80.1587 m 0.2501 0 14 61.3838 (Name goes in here)

A thumbnail preview file may be viewed with standard browser technology.

After viewing the preview file, the customer makes any necessary or desired changes via the edit form, including insertion of the employee name. The edit form is then returned to the print bureau for processing by the proprietary software application program. During this process, revised records are created for the PostScript output file such as in the following example:

1 setchc 0 0 0 1 C

2 9 9 f

46.3543 80.1587 m 0.25101 0 10 43.84557 (John Smith)

A detailed description of some of the codes used in the foregoing example is as follows:

The sequence 0 0 0 1 C describes the colour to be applied to the words ‘John Smith’. The numbers in the sequence represent cyan, magenta, yellow and black values. In the example, the colour is black. If the sequence is changed to 1 0 0 0 C, the colour would change to cyan and if the sequence is changed to 0 1 1 0 C, the colour would change to red.

The sequence 2 9 9 f represents a description of the font and style used and refers to the font embedded in the code.

The number 46.3543 represents the X-coordinate of the position of the words ‘John Smith’. As this number increases, the wording or object will move to the right and as the number decreases, the wording or object will move to the left (along the horizontal or X-axis). The X-coordinate origin (0) is located at the top left corner of the bounding box.

Similarly, the number 80.1587 represents the Y-coordinate of the position of the words ‘John Smith’. As this number increases, the wording or object will move down and as the number decreases, the wording or object will move up (along the vertical or Y-axis). The Y-coordinate origin (0) is located at the top left corner of the bounding box.

The two numbers immediately preceeding the field (‘John Smith’), 10 and 43.84557, represent the number of characters in the field and the length of the line, respectively. It is therefore possible to calculate the line length depending on the number of characters used.

If the name was changed to ‘Robert Thompson’, the two numbers immediately preceeding the name field would change to 15 and 65.76835.

In the absence of further necessary changes or approval procedures, the revised business card incorporating the customer's edited changes can now be produced by means of the new PostScript output file.

A significant advantage of this method and system is that new business cards can be produced with vastly reduced turnaround time. The name of a new employee can be simply substituted by the customer, thus obviating the need for the conventional exchange of instructions, proofs and acceptance.

Although the description is directed towards a printing service performed by a print bureau for a customer, the proprietary software application program can also be sold or licensed to a customer. For large organisations, this permits a simple and convenient means of controlling the printing of business cards and forms (eg. invoices, letterheads, etc) with regard to issues such as quick turnaround time, cost and standardisation.

### Computer Implementation

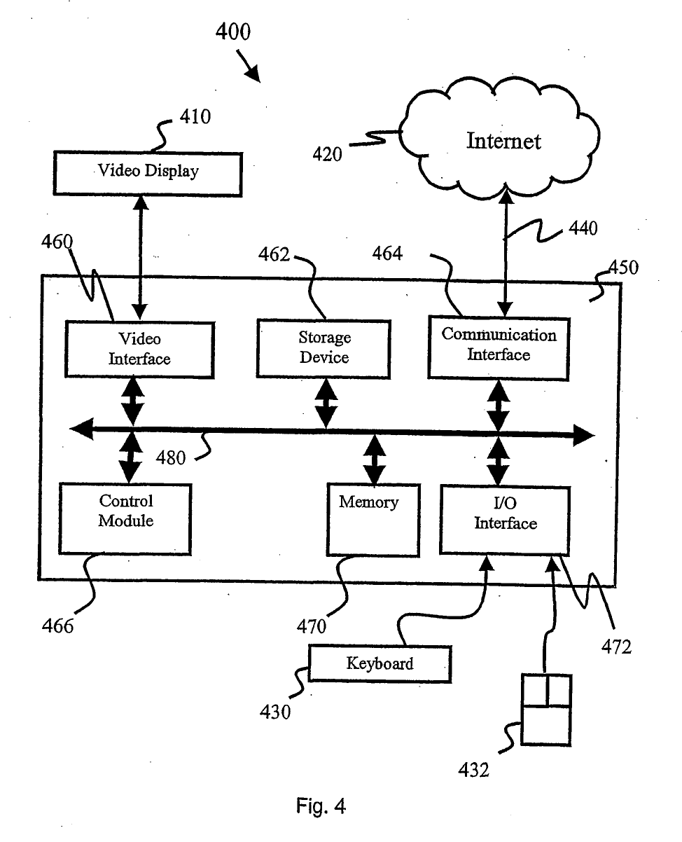

The proprietary computer software program can be implemented using a computer program product in conjunction with a computer system 400 as shown in FIG. 4. In is particular, the method steps of FIG. 3 can be implemented as software, or computer readable program code, executing on the computer system 400.

The computer system 400 includes a computer 450, a video display 410, and input devices 430, 432. In addition, the computer system 400 can have any of a number of other output devices including line printers, laser printers, plotters, and other reproduction devices connected to the computer 450. The computer system 400 can be connected to one or more other computers via a communication interface 464 using an appropriate communication channel 440 such as a modem communications path, an electronic network, or the like. The network may include a local area network (LAN), a wide area network (WAN), an Intranet, and/or the Internet 420.

The computer 450 includes the control module 466, a memory 470 that may include random access memory (RAM) and read-only memory (ROM), input/output (I/O) interfaces 464, 472, a video interface 460, and one or more storage devices generally represented by the storage device 462. The control module 466 is implemented using a central processing unit (CPU) that executes or runs a computer readable program code that performs a particular function or related set of functions.

The video interface 460 is connected to the video display 410 and provides video signals from the computer 450 for display on the video display 410. User input to operate the computer 450 can be provided by one or more of the input devices 430, 432 via the I/O interface 472. For example, a user of the computer 450 can use a keyboard as I/O interface 430 and/or a pointing device such as a mouse as I/O interface 432. The keyboard and the mouse provide input to the computer 450. The storage device 462 can consist of one or more of the following: a floppy disk, a hard disk drive, a magneto-optical disk drive, CD-ROM, magnetic tape or any other of a number of non-volatile storage devices well known to those skilled in the art. Each of the elements in the computer system 450 is typically connected to other devices via a bus 480 that in turn can consist of data, address, and control buses.

The processes shown in FIGS. 1 and 3 of the accompanying drawings can be effected by instructions in the software that are carried out by the computer system 400. Again, the software may be implemented as one or more modules for implementing the method steps.

In particular, the software may be stored in a computer readable medium, including the storage device 462 or that is downloaded from a remote location via the communications interface 464 and communications channel 440 from the Internet 420 or another network location or site. The computer system 400 includes the computer readable medium having such software or program code recorded such that instructions of the software or the program code can be carried out.

The computer system 400 is provided for illustrative purposes and other configurations can be employed without departing from the scope and spirit of the invention. The foregoing is merely an example of the types of computers or computer systems with which the embodiments of the invention may be practised. Typically, the processes of the embodiments are resident as software or a computer readable program code recorded on a hard disk drive as the computer readable medium and read and controlled using the control module 466. Intermediate storage of the program code and any data including entities, tickets, and the like may be accomplished using the memory 470, possibly in concert with the storage device 462.

In some instances, the program may be supplied to the user encoded on a CD-ROM or a floppy disk (both generally depicted by the storage device 462), or alternatively could be read by the user from the network via a modem device connected to the computer 450. Still further, the computer system 400 can load the software from other computer readable media. This may include magnetic tape, a ROM or integrated circuit, a magneto-optical disk, a radio or infra-red transmission channel between the computer and another device, a computer readable card such as a PCMCIA card, and the Internet 420 and Intranets including email transmissions and information recorded on Internet sites and the like. The foregoing are merely examples of relevant computer readable media Other computer readable media may be practised without departing from the scope and spirit of the invention.

The processes shown in FIGS. 1 and 3 of the accompanying drawings can be realised in a centralised fashion in one computer system 400, or in a distributed fashion where different elements are spread across several interconnected computer systems.

Computer program means or computer program in the present context mean any expression, in any language, code or notation, of a set of instructions intended to cause a system having an information processing capability to perform a particular function either directly or after either or both of the following: a) conversion to another language, code or notation or b) reproduction in a different material form.

The forgoing describes only a few arrangements and/or embodiments of the present invention, and modifications and/or changes can be made thereto without departing from the scope and spirit of the invention, the arrangements and/or embodiments being illustrative and not restrictive.

We claim:

1. A method for editing a document to be rendered, including the steps of:
generating one or more computer files representative of the document to be rendered, wherein at least one of said computer files comprises instructions in a page description language for describing at least a portion of said document to be rendered; and
editing one or more data fields of at least one of said representative computer files in accordance with predetermined rules;
wherein said editing step is performed independently of one or more computer software application programs used to create the original document.

2. The method of claim 1, including the further step of rendering the edited document independently of one or more computer software application programs used to create the original document, wherein said rendering includes one or more steps from the group consisting of:
printing said digital representation on print media; and
displaying said digital representation on a display monitor.

3. The method of claim 2, wherein said representative computer files include:
a first representative computer file comprising instructions in a page description language for describing said document to be rendered; and
one or more secondary representative computer file/s, wherein at least one of said secondary file/s includes one or more data field/s, said data field/s corresponding to one or more data field/s in said first representative computer file.

4. The method of claim 3, wherein said editing step is performed to one or more data field/s of one or more of said secondary representative computer file/s.

5. The method of claim 3, wherein said first representative computer file comprises a PostScript® file.

6. The method of claim 3 or claim 4, wherein at least one of said secondary representative computer file/s comprises a file of format compatible with prevailing standard client-server technology.

7. The method of claim 4, including the further step of:
generating a further computer file in a page description language, said further computer file representative of said document to be rendered, wherein said further computer file includes one or more data field/s modified in accordance with editing changes made in corresponding data field/s of said one or more secondary representative computer files and in accordance with predetermined rules.

8. The method of claim 7, wherein said further representative computer file comprises a PostScript® file.

9. A system for editing a document to be rendered including:
processing means for generating one or more computer files representative of the document to be rendered, wherein at least one of said computer files comprises instructions in a page description language for describing at least a portion of said document to be rendered; and
processing means for editing one or more data fields of at least one of said representative computer files in accordance with predetermined rules;
wherein said processing means for editing is independent of one or more computer software application programs used to create the original document.

10. The system of claim 9, further including processing means for rendering the edited document independently of one or more computer software application programs used to create the original document, wherein said processing means for rendering includes one or more processing means from the group consisting of:
processing means for printing said digital representation on print media; and
processing means for displaying said digital representation on a display monitor.

11. The system of claim 10, wherein said representative computer files include:
a first representative computer file comprising instructions in a page description language for describing said document to be rendered; and
one or more secondary representative computer file/s, wherein at least one of said secondary file/s includes one or more data field/s, said data field/s corresponding to one or more data field/s in said first representative computer file.

12. The system of claim 11, wherein said processing means for editing performs changes to one or more data field/s of one or more of said secondary representative computer file/s.

13. The system of claim 12, wherein said processing means for editing comprises a second computer system located remotely to a first computer system used to generate said one or more secondary representative file/s.

14. The system of claim 13, wherein said first and second computer systems are inter-connected by an interconnecting means selected from the group consisting of the Internet, an intranet, a Wide Area Network (WAN), a Local Area Network (LAN), a direct connection, any client-server relationship, and any combination of said interconnecting means.

15. The system of claim 11, wherein said first representative computer file comprises a PostScript® file.

16. The system of claim 11 or claim 12, wherein at least one of said secondary representative computer file/s comprises a file of format compatible with prevailing standard client-server technology.

17. The system of claim 12, further including:
processing means for generating a further computer file in a page description language, said further computer file representative of said document to be rendered, wherein said further computer file includes one or more data field/s modified in accordance with the editing changes in corresponding data field/s of said one or more secondary representative computer files and in accordance with predetermined rules.

18. The system of claim 17, wherein said further representative computer file comprises a PostScript® file.

19. A computer program product having a computer readable medium having a computer program recorded therein for editing a document to be rendered including:
computer program code means for generating one or more computer files representative of the document to be rendered, wherein at least one of said computer files comprises instructions in a page description language for describing at least a portion of said document to be rendered; and
computer program code means for editing one or more data fields of at least one of said representative computer files in accordance with predetermined rules;
wherein said computer program code means for editing is independent of one or more computer software application programs used to create the original document.

20. The computer program product of claim 19, further including computer program code means for rendering the edited document independently of one or more computer software application programs used to create the original document, wherein said computer program code means for rendering includes one or more computer program code means from the group consisting of:
computer program code means for printing said digital representation on print media; and
computer program code means for displaying said digital representation on a display monitor.

21. The computer program product of claim 20, wherein said representative computer files include:
a first representative computer file comprising instructions in a page description language for describing said document to be rendered; and
one or more secondary representative computer file/s, wherein at least one of said secondary file/s includes one or more data field/s, said data field/s corresponding to one or more data field/s in said first representative computer file.

22. The computer program product of claim 21, wherein said computer program code means for editing performs changes to one or more data field/s of one or more of said secondary representative computer file/s.

23. The computer program product of claim 22, wherein said computer program code means for editing executes on a second computer system located remotely to a first computer system used to generate said one or more secondary representative file/s.

24. The computer program product of claim 23, wherein said first and second computer systems are inter-connected by an interconnecting means selected from the group consisting of the Internet, an intranet, a Wide Area Network (WAN), a Local Area Network (LAN), a direct connection, any client-server relationship, and any combination of said interconnecting means.

25. The computer program product of claim 21, wherein said first representative computer file comprises a PostScript® file.

26. The computer program product of claim 21 or claim 22, wherein at least one of said secondary representative computer file/s comprises a file of format compatible with prevailing standard client-server technology.

27. The computer program product of claim 22, further including:
computer program code means for generating a further representative computer file in a page description language, said further computer file representative of said document to be rendered, wherein said further computer file includes one or more data field/s modified in accordance with the editing changes in corresponding data field/s of said one or more secondary representative computer files and in accordance with predetermined rules.

28. The computer program product of claim 27, wherein said further representative computer file comprises a PostScript® file.
